(19) United States
(12) Patent Application Publication
(10) Pub. No.: US 2019/0275442 A1
(43) Pub. Date: Sep. 12, 2019

(54) MODULAR EXTRACTION VESSEL AND ASSOCIATED METHODS

(71) Applicant: Waters Technologies Corporation, Milford, MA (US)

(72) Inventors: Michael O. Fogwill, South Grafton, MA (US); Keith Fadgen, Hope Valley, RI (US); Scott Kelley, Brookline, MA (US); Joseph D. Michienzi, Plainville, MA (US)

(21) Appl. No.: 15/915,847

(22) Filed: Mar. 8, 2018

(51) Int. Cl. B01D 11/02

(52) U.S. Cl. CPC B01D 11/0203

(57) ABSTRACT

Exemplary embodiments are directed to a method for diffusing fluid flow within a modular extraction vessel. A modular extraction vessel can be assembled using a plurality of extraction vessel chambers, and each extraction vessel chamber is associated with at least one diffuser element. An extracting solvent is introduced into the modular extraction vessel, and the extracting solvent flows through the extraction vessel chambers. By flowing through the extraction vessel chambers and diffusers, the flow path of the extracting solvent is diffused along an extraction path.

### TECHNICAL FIELD

The present disclosure relates to an extraction vessel and, in particular, to a modular extraction vessel that redistributes flow of an extracting solvent.

### BACKGROUND

Supercritical fluid extraction (SFE) is a process of separating one component in a solid or semisolid matrix from other components in the matrix using supercritical fluids as the extracting solvent. SFE extraction can be performed by passing an extracting solvent, such as compressed CO₂, through an extraction vessel filled with a packed matrix. However, channeling of the extracting solvent can occur as it passes through the packed matrix. In particular, the extracting solvent can choose the path of least resistance through the packed matrix, thereby channeling into particular regions of the packed matrix. Channeling of the extracting solvent prevents substantially even flow distribution of the extracting solvent through the packed matrix, which reduces yield of the extract or decreases the extraction time.

### SUMMARY

Diffusing an extracting solvent flow within an extraction system and preventing channeling of the extracting solvent poses a number of challenges. Particularly in large volume extraction systems, it may be difficult to prevent channeling through each portion of the extraction vessel. In general, certain embodiments of the present technology feature a modular extraction vessel that includes a number of extraction vessel chambers. Each of these chambers can be associated with a diffuser in order to disperse the extraction solvent within each chamber.

In one aspect, the present technology relates to a method for diffusing fluid flow within a modular extraction vessel. The method includes assembling a modular extraction vessel including a plurality of extraction vessel chambers, wherein each extraction vessel chamber is associated with at least one diffuser. The method also includes introducing an extracting solvent into the modular extraction vessel; flowing the extracting solvent through the plurality of extraction vessel chambers; and diffusing a flow path of the extracting solvent along an extraction path using the diffusers associated with the extraction vessel chambers.

In a non-limiting example, the positioning of the extraction vessel chambers and the diffusers redistributes flow of the extracting solvent along the extraction path more equally than a single extraction vessel. In another non-limiting example, the extraction vessel chambers are arranged in parallel within the modular extraction vessel. In another non-limiting example, the extraction vessel chambers are arranged in series within the modular extraction vessel. In another non-limiting example, a fluid diffuser is positioned between each extraction vessel chamber arranged in series. In another non-limiting example, assembling the modular extraction vessel includes coupling each extraction vessel chamber in series with a fluid diffuser between each extraction vessel chamber. In another non-limiting example, flowing the extracting solvent through the plurality of extraction vessel chambers includes flowing the extracting solvent through a matrix packed within the extraction vessel chambers. In another non-limiting example, flowing the extracting solvent through the plurality of extraction vessel chambers includes selectively directing the extracting solvent through one or more extraction vessel chambers using a fluid channel and valve system in fluid communication with an inlet and an outlet of each extraction vessel chamber. In another non-limiting example, the method also includes individually controlling pressure within one or more extraction vessel chambers using the fluid channel and valve system in order to pressurize or depressurize individual extraction vessel chambers. In another non-limiting example, the method also includes performing a pressure cycle on each of the extraction vessel chambers in series. In another non-limiting example, the method also includes controlling pressure within a first extraction vessel chamber in order to bring the first extraction vessel chamber to equilibrium; and controlling pressure within a second extraction vessel chamber in order to dynamically perform extraction within the second extraction vessel chamber. In another non-limiting example, the extracting solvent is compressed CO₂, or compressed CO₂ and a co-solvent. In another non-limiting example, diffusing the flow path of the extracting solvent results in a substantially more even flow distribution of the extracting solvent through the modular extraction vessel. In another non-limiting example, each of the diffusers is formed from a porous sintered metal. In another non-limiting example, the method also includes determining an intended volume for the modular extraction vessel; determining a number of extraction vessel chambers associated with the intended volume; and assembling the modular extract vessel using the determined number of extraction vessel chambers in order to form a modular extraction vessel having the intended volume. In another non-limiting example, the method also includes redistributing flow of the extracting solvent using the diffusers associated with the extraction vessel chambers. In another non-limiting example, the diffusers associated with the extraction vessel chambers include a static seal disposed between an inner surface of the extraction vessel chamber. In another non-limiting example, the diffusers associated with the extraction vessel chambers include a dynamic seal disposed between an inner surface of the extraction vessel chamber.

The above aspects of the technology provide numerous advantages. For example, the modular design of the extraction vessel allows for more thorough diffusion of the extracting solvent, especially when coupled with diffusers associated with each extraction vessel chamber. The modular extraction vessel disclosed herein can be easily disassembled and cleaned. Furthermore, the modular extraction vessel can be customized to a desired volume depending on the number of extraction vessel chambers used.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a diagrammatic, cross-sectional side view of an exemplary extraction vessel in accordance with an embodiment of the present disclosure.

FIG. 2 is a flow chart of an example method for assembling and using a modular extraction vessel, according to an embodiment of the present disclosure.

FIG. 3 is a diagrammatic, cross-sectional side view of an example modular extraction vessel in accordance with embodiments of the present disclosure.

FIG. 4 is a diagrammatic, cross-sectional side view of another example modular extraction vessel in accordance with embodiments of the present disclosure.

FIG. 5 is a diagrammatic, cross-sectional side view of an example modular extraction vessel with extraction vessel chambers arranged in parallel, in accordance with embodiments of the present disclosure.

FIG. 6 is a diagrammatic, cross-sectional side view of a diffuser assembly.

### DESCRIPTION OF EXEMPLARY EMBODIMENTS

In general, the present technology is related to a modular extraction vessel configured to diffuse a flow path of an extraction solvent. Extraction vessels are generally packed with a matrix and an extracting solvent is passed through the extraction vessel to extract substances from the packed matrix. Channeling of the extracting solvent can occur in conventional extraction vessels, resulting in a reduction in yield of the extract. In some embodiments, the modular extraction vessels disclosed herein are configured with a number of extraction vessel chambers and diffusers, which can be arranged in series or in parallel, to prevent or minimize channeling of the extracting solvent through the packed matrix. That is, the extraction vessel chambers and the diffusers are arranged to help redistribute flow, such that the extract solvent does not channel through singularly defined paths.

Due to the redistributed flow through the packed matrix, the extraction yield from the matrix is increased and the extraction time is decreased by the modular configuration of the extraction vessel chambers, as well as the diffusers associated with each extraction vessel chamber. The modular extraction vessel can include multiple extraction vessel chambers, and one or more diffusers or diffuser assemblies can be incorporated into each extraction vessel chamber. For example, multiple diffuser assemblies can be incorporated into an extraction vessel chamber in a spaced manner to redistribute flow of the extracting solvent at multiple sections of the extraction vessel chamber. In a non-limiting example, the diffuser or diffuser assembly can include a diffuser such as the types described in U.S. patent application No. Ser. 15/915,602, which is incorporated herein by reference in its entirety. In some embodiments, one or more fixed seals can fixedly secure the position of the diffuser assembly to the body of the extraction vessel such that the diffuser assembly remains in the same position during implementation. In some embodiments, one or more dynamic seals can be used to secure the diffuser assembly to the body of the extraction vessel. In such embodiments, the dynamic seals prevent the extracting solvent from flowing around the diffuser assembly, while allowing the diffuser assembly to slide or reposition itself along the length of the extraction vessel due to upstream pressure within the extraction vessel. In certain embodiments, such sliding or repositioning compacts the packed matrix with the diffuser assembly during extraction.

In a non-limiting example, the extraction vessel chambers can be assembled in parallel or in series in order to form the modular extraction vessel. Each extraction vessel chamber can be partially filled, in some embodiments, in order to allow movement of the matrix within the chamber and help prevent channeling of the extracting solvent. The modular design of the extraction vessel facilitates movement of the matrix because of the decreased volume of the extraction vessel chambers. For example, the mass of material in a partially packed large extraction vessel (e.g. 5 L) would require a large force from the incoming extracting solvent in order to move the matrix. However, less force would be required to move a matrix that is divided into two extraction vessel chambers having half the volume. In a non-limiting example, the modular extraction vessel is assembled from smaller extraction vessel chambers, each associated with a frit or diffuser. In such an example, the decreased volume of the individual extraction vessel chambers allows easier movement of the matrix and promotes more uniform flow through each chamber. Additionally, the modular extraction vessel allows for variation in the overall volume of the extraction system. Currently, if a user wants to employ a 500 mL vessel and a 2 L vessel, two separate vessels would be needed. However, with a modular extraction vessel such as the ones described herein, a single platform could be employed to offer multiple sizes by adding or removing the extraction chambers as needed.

In another non-limiting example, the modular extraction vessel system may have the ability to selectively pressurize or depressurize individual extraction vessel chambers. Rapidly depressurizing and pressurizing an extraction vessel can break up the matrix and help prevent channeling of the extracting solvent, in some embodiments. By incorporating a fluid channel and a set of valves within the modular extraction system, a user can selectively perform a pressure cycle on one or more of the extraction vessel chambers.

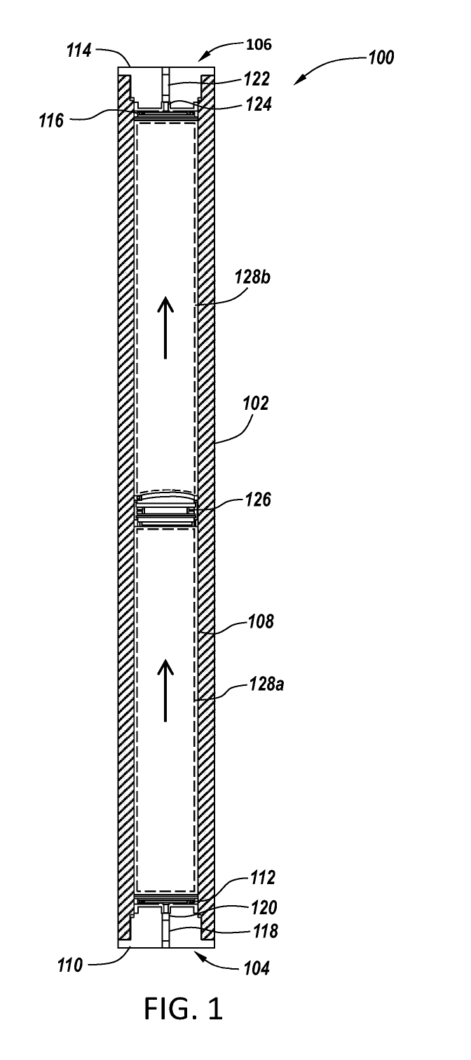

With reference to FIG. 1, a diagrammatic, cross-sectional side view of an exemplary extraction vessel 100 is shown, according to an embodiment of the present disclosure. The extraction vessel 100 includes an elongated body 102 (e.g., a housing) with an inlet end 104 and an outlet end 106. The body 102 includes a passage 108 extending between the inlet end 104 and the outlet end 106. In some embodiments, the body 102 and the passage 108 define substantially cylindrical configurations.

The extraction vessel 100 includes an inlet cap 110 and an inlet frit holder assembly 112 secured to the inlet cap 110. The extraction vessel 100 includes an outlet cap 114 and an outlet frit holder assembly 116 secured to the outlet cap 114. In some embodiments, the inlet cap 110 and inlet frit holder assembly 112 include complementary threads such that the inlet frit holder assembly 112 can be threaded into the inlet cap 110. In some embodiments, the outlet cap 114 and outlet frit holder assembly 116 include complementary threads such that the outlet frit holder assembly 116 can be threaded into the outlet cap 114.

The inlet cap 110 includes an inlet passage 118 for introduction of an extracting solvent (e.g., a solvent gas or liquid, such as compressed CO₂) into the extraction vessel 100. The inlet frit holder assembly 112 includes an inner passage 120 in fluid communication with the inlet passage 118 with the passage 108 of the body 102. The outlet cap 114 includes an outlet passage 122 for exit of the extracting solvent from the extraction vessel 100. The outlet frit holder assembly 116 includes an inner passage 124 in fluid communication with the passage 108 of the body 102 with the outlet passage 122. Thus, the extracting solvent can travel along an extraction path extending between the inlet passage 118 and the outlet passage 122.

The extraction vessel 100 includes one or more diffuser assemblies 126 disposed within the passage 108 and between the inlet and outlet caps 110, 114. Thus, although illustrated as including a single diffuser assembly 126, it should be understood that the extraction vessel 100 can include multiple diffuser assemblies 126 disposed within the passage 108 and spaced from each other. Matrix 128a, 128b (e.g., an organic material (such as a plant matrix), an inorganic material, or the like) is packed into the passage 108, against the diffuser assembly 126, and against the inlet and outlet caps 110, 114 for extraction of a substance. The matrix 128a represents the “upstream matrix”, i.e., upstream of the diffuser assembly 126, and the matrix 128b represents the “downstream matrix”, i.e., downstream of the diffuser assembly 126. As will be discussed in greater detail below, as the extracting solvent is passed along the extraction path of the extraction vessel 100 through the packed matrix 128a, 128b,the diffuser assembly 126 redistributes flow of the extracting solvent along the extraction path, resulting in a substantially more even flow distribution of the extracting solvent through the extraction vessel 100. In particular, rather than passing through the path of least resistance in the packed matrix 128a, 128b and creating channels of extracting solvent flow with less exposure to the matrix, the diffuser assembly 126 terminates flow channels upstream of the diffuser assembly 126 and redistributes the extracting solvent flow across the entire cross-section of the packed matrix 128a, 128b to minimize formation of channels downstream of the matrix 128a, 128b, thereby increasing the amount of plant material contacted by the extracting solvent and the overall amount of material extracted per unit time.

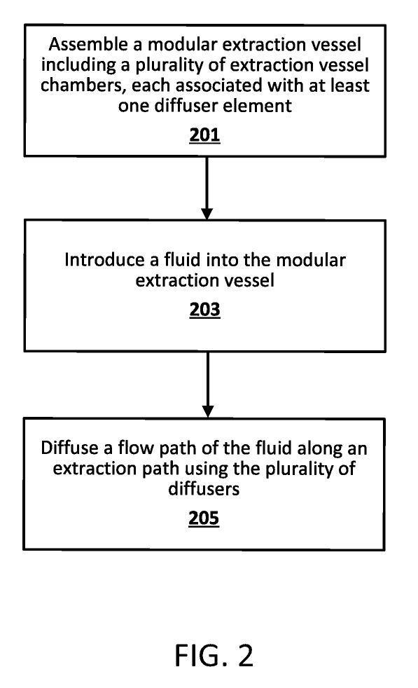

FIG. 2 is a flow chart of an example method for assembling and using a modular extraction vessel, according to an embodiment of the present disclosure. In step 201, a modular extraction vessel is assembled including a number of extraction vessel chambers. Each extraction vessel chamber is associated with one or more diffusers or diffuser assemblies, as described above. In a non-limiting example, each of the extraction vessel chambers is arranged in series to form the modular extraction vessel. For example, each extraction vessel chamber can be configured to mechanically couple together end-to-end, via threading or some other coupling technique. A diffuser can be positioned between each of the extraction vessel chambers, as well as between an inlet cap and the first extraction vessel chamber and an outlet cap and the last extraction vessel chamber. In another non-limiting example, the extraction vessel chambers can be arranged in parallel.

As will be appreciated, the overall volume of the modular extraction vessel can depend on the number of extraction vessel chambers. In a non-limiting example, the intended volume of the extraction vessel can be determined initially, and a number of extraction vessel chambers can also be determined in order to provide a modular extraction vessel having the desired end volume. In such an example, assembling the modular extraction vessel can include assembling the determined number of extraction vessel chambers, in series or in parallel, in order to form a modular extraction vessel having the intended volume.

In step 203, an extracting solvent is introduced into the modular extraction vessel. In a non-limiting example, the extracting solvent flows through the plurality of extraction vessel chambers, which are packed with a matrix, once introduced within the modular extraction vessel. The extracting solvent can be, for example, compressed CO₂ or a combination of compressed CO₂ and a co-solvent. Depending on whether the extraction vessel chambers are arranged in series or in parallel, all or a portion of the extracting solvent can be directed to flow through each one of the extraction vessel chambers. For example, if the extraction vessel chambers are arranged in series from the inlet to the outlet of the modular extraction vessel, then all of the extracting solvent can be directed to flow through each of the extraction vessel chambers. However, if the extraction vessel chambers are arranged in parallel, the extracting solvent can be divided into several flow streams corresponding to each of the extraction vessel chambers.

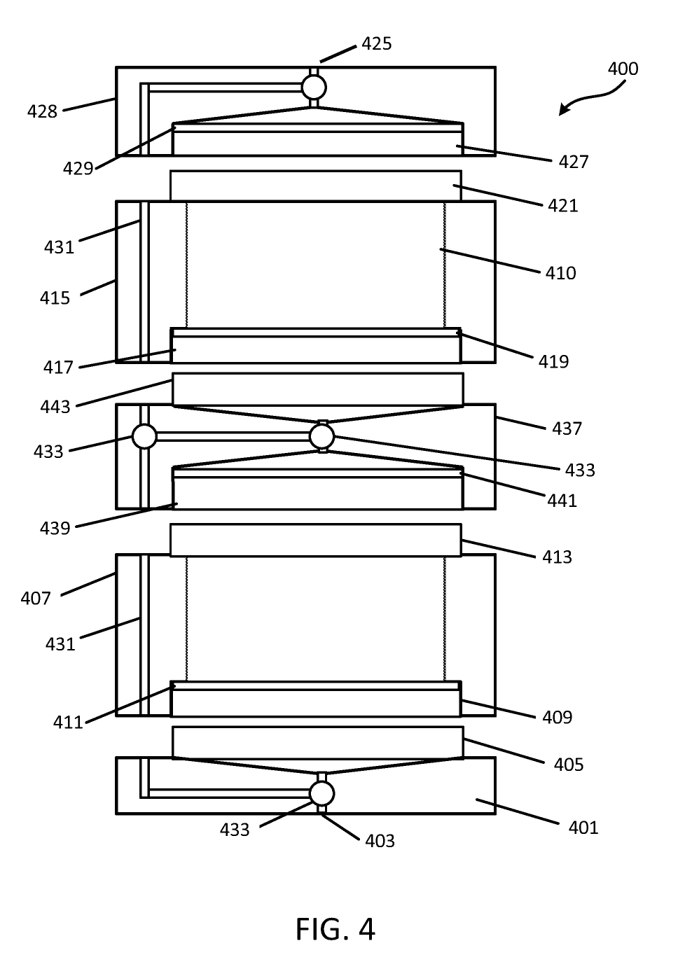

In a non-limiting example, flowing the extracting solvent through the plurality of extraction vessel chambers can include selectively directing the extracting solvent through one or more of the extraction vessel chambers. For example, the modular extraction vessel can include a fluid channel and valve system configured to control the flow of extracting solvent to and from each of the extraction vessel chambers. Such an embodiment is described in more detail with respect to FIG. 4 below. In such a configuration, the operation of the valves can selectively direct the extracting solvent through one or more extraction vessel chambers.

In step 205, the flow path of the extracting solvent is diffused along an extraction path using the diffusers associated with each of the extraction vessel chambers. In a non-limiting example, the positioning of the extraction vessel chambers and the diffusers redistributes flow of the extracting solvent along the extraction path more equally than a single extraction vessel. In another non-limiting example, diffusing the flow path of the extracting solvent with the modular design disclosed herein results in substantially more even flow distribution of the extracting solvent through the modular extraction vessel. Each of the diffusers can be formed, for example, from a porous sintered metal or other porous material.

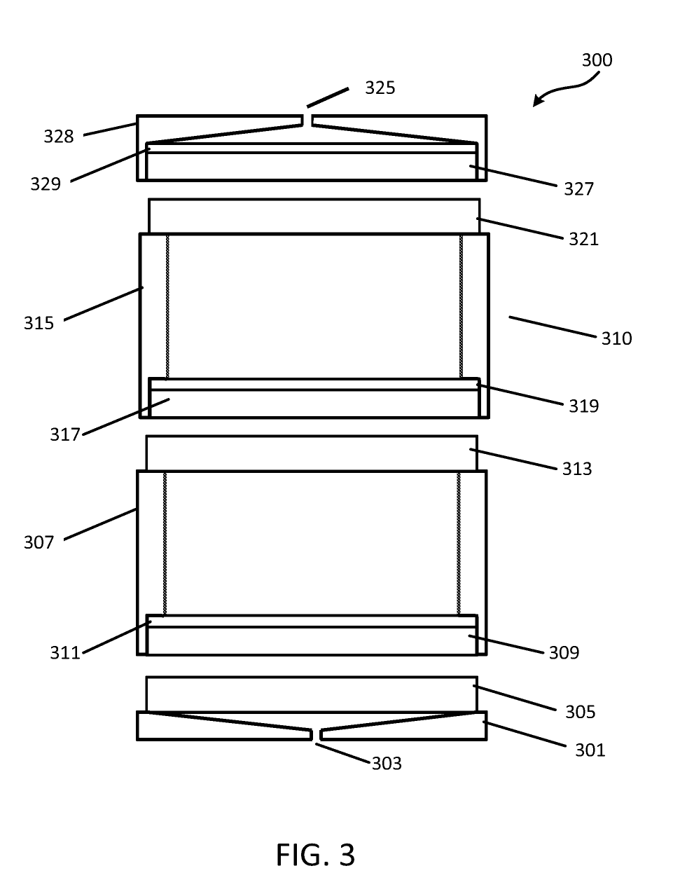

FIG. 3 is a diagrammatic, cross-sectional side view of an example modular extraction vessel 300 in accordance with embodiments of the present disclosure. In this example embodiment, the modular extraction vessel 300 includes two extraction vessel chambers 307, 315. The first extraction vessel chamber 307 includes a threaded receiving portion 309 configured to receive both a first diffuser 311 as well as a protruded threaded portion 305 of an extraction vessel inlet cap 301. The inlet cap 301 includes a fluid inlet 303 configured to receive an extracting solvent into the modular extraction vessel 300. When the inlet cap 301 is coupled to the first extraction vessel chamber 307, the first diffuser 311 can be secured to the entrance of the first extraction vessel chamber 307, in some embodiments.

The first extraction chamber 307 also includes a protruding threaded portion 313 configured to couple with a threaded receiving portion 317 of the second extraction vessel chamber 315. The threaded receiving portion 317 is also configured and shaped to receive a second diffuser 319. In some embodiments, when the first extraction vessel chamber 307 is coupled to the second extraction vessel chamber 315, the second diffuser 319 is secured between the extraction vessel chambers 307, 315 such that the extracting solvent passing to the second extraction vessel chamber 315 is diffused through the second diffuser 319. As described above, an interior portion 310 of the extraction vessel chambers 307, 315 can be packed with a matrix, such as a plant matrix, for example.

The second extraction vessel chamber 315 also includes a protruding threaded portion 321, in this example embodiment. This threaded portion 321 is configured to couple with a threaded receiving portion 327 of an outlet cap 328. The threaded receiving portion 327 of the outlet cap 328 is also configured to receive a third diffuser 329, in this example embodiment. When the outlet cap 328 is coupled to the second extraction vessel chamber 315, the third diffuser 329 is secured to the outlet of the second extraction vessel chamber 315, in some embodiments. The outlet cap 328 also includes a fluid outlet 325 configured to allow fluid to flow from the modular extraction vessel 300.

The modular extraction vessel 300 shown in FIG. 3 includes only two extraction vessel chambers. However, one skilled in the art will realize that more or less extraction vessel chambers can be implemented. For example, three or more extraction vessel chambers could be coupled in series, as shown in the example of FIG. 3, in order to make a larger modular extraction vessel and increase the total volume of the system.

FIG. 4 is a diagrammatic, cross-sectional side view of another example modular extraction vessel 400 in accordance with embodiments of the present disclosure. In this example embodiment, the modular extraction vessel 400 includes two extraction vessel chambers 407, 415. The first extraction vessel chamber 407 includes a threaded receiving portion 409 configured to receive both a first diffuser 411 as well as a protruded threaded portion 405 of an extraction vessel inlet cap 401. The inlet cap 401 includes a fluid inlet 403 configured to receive an extracting solvent into the modular extraction vessel 400. This fluid inlet 403 accesses a fluid channel 431 that flows alongside each portion of the modular extraction vessel and is configured to access, via one or more valves 433, the inlet and outlet of each extraction vessel chamber. When the inlet cap 401 is coupled to the first extraction vessel chamber 407, the first diffuser 411 can be secured to the entrance of the first extraction vessel chamber 407, in some embodiments.

The first extraction chamber 407 also includes a protruding threaded portion 413 configured to couple with a threaded receiving portion 439 of a connector 437. In this non-limiting example, the connector 437 is configured to be secured between the first extraction vessel chamber 407 and the second extraction vessel chamber 415. The threaded receiving portion 439 of the connector 437 is also configured and shaped to receive a second diffuser 441. In a non-limiting example, the second diffuser 441 is secured between the first extraction vessel chamber 407 and the connector 437 when they are coupled together. The connector 437 also includes a protruding threaded portion 443 configured to couple with a threaded receiving portion 417 of the second extraction vessel chamber 415. The threaded receiving portion 417 is also configured and shaped to receive a third diffuser 419. In a non-limiting example, the third diffuser 419 can be secured between the connector 437 and the second extraction vessel chamber 415 when they are coupled. As described above, an interior portion 410 of the extraction vessel chambers 407, 415 can be packed with a matrix, such as a plant matrix, for example.

In a non-limiting example, the fluid channel 431 also passes through a portion of the connector 437 such that one or more valves 433 can direct the extracting solvent to and from the outlet of the first extraction vessel chamber 407 and the inlet of the second extraction vessel chamber 415. The valves 433 can be operated, in some embodiments, in order to selectively direct all or a portion of the extracting solvent through one or both of the extraction vessel chambers 407, 415. For example, if the matrix within the first extraction vessel chamber 407 is depleted after a certain amount of time, the valves 433 can bypass the first extraction vessel chamber 407 using the fluid channel 431 and direct the fluid only through the second extraction vessel chamber 415. In this way, the extraction chambers can be functionally operated in either a parallel or series configuration.

In a non-limiting example, the second extraction vessel chamber 415 also includes a protruding threaded portion 421, in this example embodiment. This threaded portion 421 is configured to couple with a threaded receiving portion 427 of an outlet cap 428. The threaded receiving portion 427 of the outlet cap 428 is also configured to receive a fourth diffuser 429, in this example embodiment. When the outlet cap 428 is coupled to the second extraction vessel chamber 415, the third diffuser 429 is secured to the outlet of the second extraction vessel chamber 415, in some embodiments. The outlet cap 428 also includes a fluid outlet 425 configured to allow fluid to flow from the modular extraction vessel 400.

In another non-limiting example, the modular or segmented extraction vessel 400 is able to separately control the pressure within each individual extraction vessel chamber 407, 415. In a non-limiting example, the modular extraction vessel 400 is able to individually pressurize or depressurize the extraction vessel chambers 407, 415 using the fluid channel 431 and the valves 433. Rapid decompression of the extraction vessel chambers 407, 415 may help break up channels and mix the matrix, and this selective decompression and pressurization of individual chambers can be achieved using the fluid channel 431 and the valves 433. In a non-limiting example, performing a pressure cycle on only one of the extraction vessel chambers 407, 415 may be completed more rapidly than on a larger extraction vessel or on each of the chambers simultaneously. Performing a pressure cycle on each extraction vessel chamber can be performed in series, in some embodiments, or to statically equilibrate one chamber while dynamically extracting another.

The modular extraction vessel 400 shown in FIG. 4 includes only two extraction vessel chambers. However, one skilled in the art will realize that more or less extraction vessel chambers can be implemented. For example, three or more extraction vessel chambers could be coupled in series in order to make a larger modular extraction vessel and increase the total volume of the system.

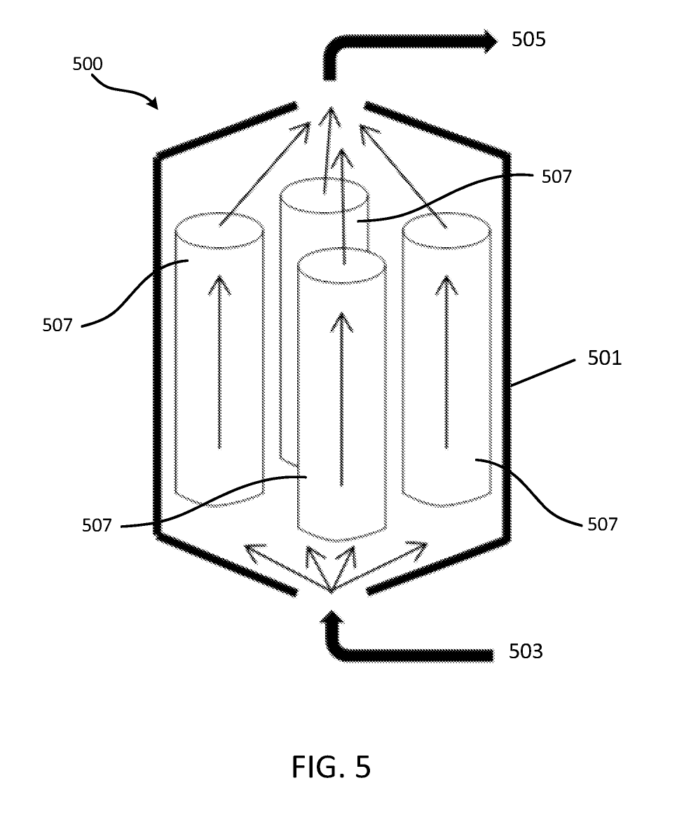

FIG. 5 is a diagrammatic, cross-sectional side view of an example modular extraction vessel 500 with extraction vessel chambers arranged in parallel, in accordance with embodiments of the present disclosure. As shown in this non-limiting example, the modular extraction vessel includes a housing 501 configured to receive the extraction vessel chambers 507. An extracting solvent can enter the modular extraction vessel 500 via a fluid inlet 503, and exit the modular extraction vessel 500 via a fluid outlet 505. As discussed above, each extraction vessel chamber 507 can include a diffuser located at an entrance to the chamber, or within the chamber as shown in FIG. 1. The decreased diameter of each extraction vessel chamber 507 may be partially packed to reduce channeling, and the smaller diameter of the individual chambers may promote more uniform flow through the packed matrix. As discussed above, the number of extraction vessel chambers 507 can be selected in order to achieve a smaller or larger overall extraction volume, in some embodiments. In a non-limiting example, a valve could be added to the inlet and outlet to select at least one extraction vessel segment. In such an example, the valves can allow the system to individually pressurize or depressurize the extraction vessel chambers 507. Rapid decompression of the extraction vessel chambers 507 may help break up channels and mix the matrix, as discussed above.

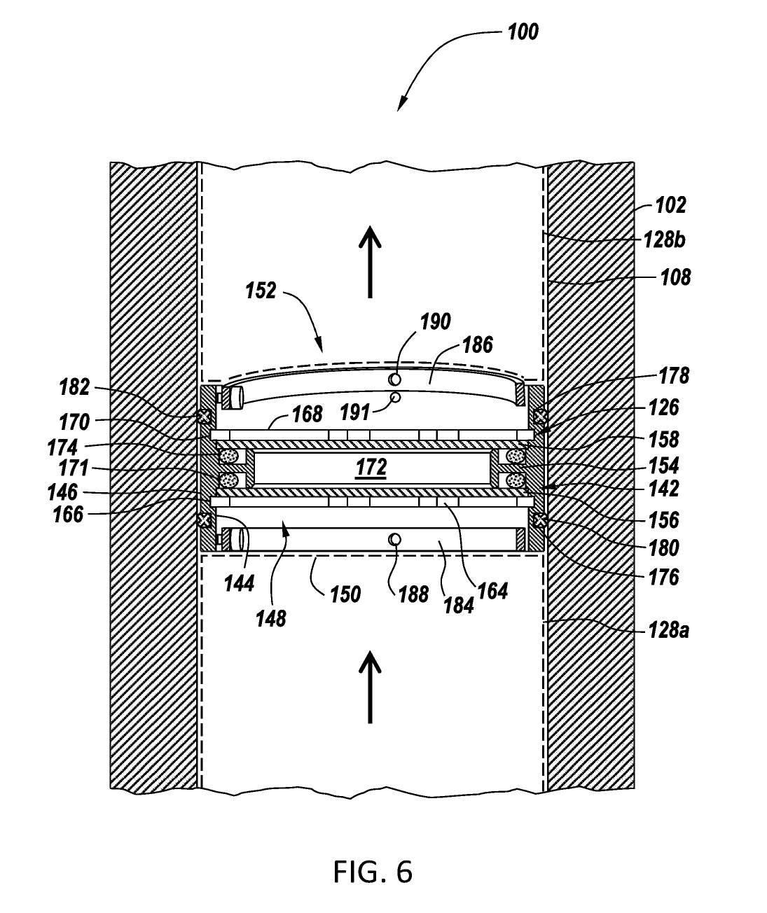

FIG. 6 is a diagrammatic, cross-sectional side view of a diffuser assembly 126. Although illustrated within an extraction vessel 100, such as the modular extraction vessel described above, it should be understood that the diffuser assembly 126 can be incorporated into a variety of extraction vessels having different configurations. In a non-limiting example, the diffuser assembly 126 includes a housing 142 configured and dimensioned to be disposed within the passage 108 of the extraction vessel 100 (e.g., a substantially cylindrical housing). The housing 142 includes an inner surface 144 and an outer surface 146, with the outer surface 146 configured to be disposed adjacent to the inner surface of the passage 108. The inner surface 144 forms a passage 148 extending through the diffuser assembly 126 between an upstream end 150 and a downstream end 152, the extracting solvent passing through the passage 148 during implementation of the diffuser assembly 126 in the extraction vessel 100.

In this example embodiment, the housing 142 includes a circumferential protrusion 154 extending from the inner surface 144. The protrusion 154 defines a substantially T-shaped cross-section. The diffuser assembly 126 includes inlet and outlet structures 156, 158 disposed within the housing 142. The inlet and outlet structures 156, 158 can each be a substantially disk-shaped frit including a plurality of openings 160, 162 extending through the thickness of the frit. In particular, the porosity of the inlet and outlet structures 156, 158 is configured for passage of the extracting solvent therethrough.

In an embodiment, each of the plurality of openings 160, 162 can be dimensioned between approximately 0.5 μm and approximately 25 μm. In an embodiment, each of the plurality of openings 160, 162 can be dimensioned between approximately 1 μm and approximately 20 μm. In an embodiment, each of the plurality of openings 160, 162 can be dimensioned between approximately 1 μm and approximately 15 μm. In an embodiment, each of the plurality of openings 160, 162 can be dimensioned between approximately 1 μm and approximately 10 μm. In an embodiment, each of the plurality of openings 160, 162 can be dimensioned as approximately 5 μm (e.g., nominally). In an embodiment, the size of the openings 160 of the inlet structure 156 can be dimensioned substantially equal to the size of the openings 162 of the outlet structure 158. In an embodiment, the size of the openings 160 of the inlet structure 156 can be dimensioned different from the size of the openings 162 of the outlet structure 158. In an embodiment, the inlet and outlet structures 156, 158 can be formed from porous sintered metal.

The inlet structure 156 can be introduced into the passage 148 from the upstream end 150 of the housing 142 and disposed against the circumferential protrusion 154. A fastener 164 (e.g., a retainer ring) can be engaged with a radial groove 166 formed in the inner surface 144 of the housing 142 to lock the inlet structure 156 in the position abutting the upstream side of the protrusion 154. The outlet structure 158 can be introduced into the passage 148 from the downstream end 152 of the housing 142 and disposed against the downstream end of the circumferential protrusion 154. A fastener 168 (e.g., a retainer ring) can be engaged with a radial groove 170 formed in the inner surface 144 of the housing 142 to lock the outlet structure 158 in the position abutting the downstream side of the protrusion 154. In some embodiments, alternative structures can be used to maintain the position of the inlet structure 156 and/or the outlet structure 158, such as a snap ring, threads, threaded components, shrink fits, elastomeric elements, welding, or the like.

The T-shaped configuration of the protrusion 154 maintains a separation between the inlet and outlet structures 156, 158 to form a mixing chamber 172 therebetween. The diffuser assembly 126 includes a first static seal 171 (e.g., an O-ring) disposed between the inner surface 144, the protrusion 154 and the inlet structure 156. The diffuser assembly 126 also includes a second static seal 174 (e.g., an O-ring) disposed between the inner surface 144, the protrusion 154 and the outlet structure 158. The first and second static seals 171, 174 prevent the extracting solvent from flowing around the inlet and/or outlet structures 156, 158, and force the extracting solvent to pass through the openings 160, 162 of the inlet and outlet structures 156, 158.

Thus, as the extracting solvent flows along the extraction path, the extracting solvent passes first through the inlet structure 156, mixes within the mixing chamber 172, and passes through the outlet structure 158. Such passage of the extracting solvent redistributes flow of the extracting solvent along the extraction path to prevent or reduce channeling of the extracting solvent through the matrix 128a, 128b (e.g., creating a substantially more even flow distribution of the extracting solvent through the extraction vessel 100). Particularly, any channeling occurring in the extracting solvent upstream of the inlet structure 156 is reset or redistributed when the extracting solvent enters the mixing chamber 172. For example, due to resistance in flow from the outlet structure 158, swirling of the extracting solvent within the mixing chamber 172 redistributes the extracting solvent to exit through the outlet structure 158 in a substantially more even manner that minimizes formation of channels in the downstream flow. The redistributed extracting solvent exits the mixing chamber 172 through the outlet structure 158 in a non-channeling flow pattern. In some embodiments, multiple diffuser assemblies 126 can be distributed along the extraction path to redistribute the extracting solvent flow pattern through the matrix 128a, 128b.

In some embodiments, the housing 142 can include one or more circumferential grooves 176, 178 formed in the outer surface 146 each configured and dimensioned to receive a seal 180, 182 (e.g., a static seal, a dynamic seal, or the like). In an embodiment where the seals 180, 182 are static seals, the seals 180, 182 maintain the static position of the diffuser assembly 126 along the extraction path and do not allow the diffuser assembly 126 to slide under pressure from the extracting solvent. The static seals 180, 182 create a fluidic seal between the housing 142 and the passage 108 of the extraction vessel 100, thereby preventing the extracting solvent from flowing around the diffuser assembly 126 within the extraction vessel 100. The substantially more even flow distribution of the extracting solvent through the extraction vessel 100 due to the diffuser assembly 126 advantageously increases the extraction efficiency of the extraction vessel 100, providing for a higher yield of extract. Increased extraction efficiency can also contribute to reduced extraction time.

In an embodiment where the seals 180, 182 are dynamic seals, the seals 180, 182 create a fluidic seal between the housing 142 and the passage 108 of the extraction vessel 100, thereby preventing the extracting solvent from flowing around the diffuser assembly 126 within the extraction vessel 100. The dynamic seals 180, 182 allow the diffuser assembly 126 to slide along the extraction path within the extraction vessel 100 under pressure of the extracting solvent, thereby compressing the downstream matrix 128b. For example, if the diffuser assembly 126 is originally disposed at a substantially central location between the inlet and outlet ends 104, 106 of the extraction vessel 100, pressure of the extracting solvent passing along the extraction path can force the diffuser assembly 126 to slide in the direction of the outlet end 106 and against the matrix 128b.

In some embodiments, the housing 142 can include one or more handles 184, 186 rotatably secured to the housing 142 and configured to be positioned in an extended position or a stored position. For example, the housing 142 can include a handle 184 disposed at the upstream end 150 and/or a handle 186 disposed at the downstream end 152. FIG. 6 shows the handle 184 positioned in a stored position, and shows the handle 186 positioned in a partially extended position. An opening 188, 190 (e.g., an engagement mechanism to be used with a spring-loaded pin, set screw, or the like) can be located on the handle 184, 186 or the inner surface 144 for engagement with a corresponding groove or opening 191 such that the handle 184, 186 can be maintained in the stored position during use of the extraction vessel 100. For example, a set screw can be passed through the opening 190 and into the corresponding groove or opening 191 to secure the handle 186 in the stored position. In the extended position, the handle 184, 186 can be used to position the diffuser assembly 126 within the extraction vessel 100 or remove the diffuser assembly 126 from the extraction vessel 100.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method for diffusing fluid flow within a modular extraction vessel, comprising:
assembling a modular extraction vessel including a plurality of extraction vessel chambers, wherein each extraction vessel chamber is associated with at least one diffuser;
introducing an extracting solvent into the modular extraction vessel;
flowing the extracting solvent through the plurality of extraction vessel chambers; and
diffusing a flow path of the extracting solvent along an extraction path using the diffusers associated with the extraction vessel chambers.

2. The method of claim 1, wherein the positioning of the extraction vessel chambers and the diffusers redistributes flow of the extracting solvent along the extraction path more equally than a single extraction vessel.

3. The method of claim 1, wherein the extraction vessel chambers are arranged in parallel within the modular extraction vessel.

4. The method of claim 1, wherein the extraction vessel chambers are arranged in series within the modular extraction vessel.

5. The method of claim 4, wherein a fluid diffuser is positioned between each extraction vessel chamber arranged in series.

6. The method of claim 1, wherein assembling the modular extraction vessel includes coupling each extraction vessel chamber in series with a fluid diffuser between each extraction vessel chamber.

7. The method of claim 1, wherein flowing the extracting solvent through the plurality of extraction vessel chambers includes flowing the extracting solvent through a matrix packed within the extraction vessel chambers.

8. The method of claim 1, wherein flowing the extracting solvent through the plurality of extraction vessel chambers includes selectively directing the extracting solvent through one or more extraction vessel chambers using a fluid channel and valve system in fluid communication with an inlet and an outlet of each extraction vessel chamber.

9. The method of claim 8, further comprising:
individually controlling pressure within one or more extraction vessel chambers using the fluid channel and valve system in order to pressurize or depressurize individual extraction vessel chambers.

10. The method of claim 9, further comprising:
performing a pressure cycle on each of the extraction vessel chambers in series.

11. The method of claim 9, further comprising:
controlling pressure within a first extraction vessel chamber in order to bring the first extraction vessel chamber to equilibrium; and
controlling pressure within a second extraction vessel chamber in order to dynamically perform extraction within the second extraction vessel chamber.

12. The method of claim 1, wherein the extracting solvent is compressed CO₂, or compressed CO₂ and a co-solvent.

13. The method of claim 1, wherein diffusing the flow path of the extracting solvent results in a substantially more even flow distribution of the extracting solvent through the modular extraction vessel.

12. The method of claim 1, wherein each of the diffusers is formed from a porous sintered metal.

14. The method of claim 1, further comprising:
determining an intended volume for the modular extraction vessel;
determining a number of extraction vessel chambers associated with the intended volume; and
assembling the modular extract vessel using the determined number of extraction vessel chambers in order to form a modular extraction vessel having the intended volume.

15. The method of claim 1, further comprising:
redistributing flow of the extracting solvent using the diffusers associated with the extraction vessel chambers.

16. The method of claim 1, wherein the diffusers associated with the extraction vessel chambers include a static seal disposed between an inner surface of the extraction vessel chamber.

17. The method of claim 1, wherein the diffusers associated with the extraction vessel chambers include a dynamic seal disposed between an inner surface of the extraction vessel chamber.
